(19) United States
(12) Patent Application Publication
(10) Pub. No.: US 2003/0045332 A1
(43) Pub. Date: Mar. 6, 2003

(54) Cellular phone holder for use in automobiles

(76) Inventors: Joel Lopez, Hacienda Heights, CA (US); Anita D. Lopez, Hacienda Heights, CA (US)

Correspondence Address: Edgar W. Averill, Jr., Averill & Varn, 8244 Painter Ave., Whittier, CA, 90602, US

(21) Appl. No.: 09/945,876

(22) Filed: Sep. 5, 2001

(51) Int. Cl. H04M 1/00

(52) U.S. Cl. 455/569; 455/550

(57) ABSTRACT

A holder for supporting a cellular phone on the front seat of a motor vehicle to permit the driver of the motor vehicle to converse over the phone without taking his or her hands off the steering wheel. The holder has a main base member with legs over the front and the back of the seat. An adjustable telescopic pivot arm is supported on the main base member and telescopes, as well as pivoting up and down. A cellular phone is held at the end of the adjustable telescopic pivot arm and may be adjusted so that the user can speak and hear over the cell phone without having to hold it.

### BACKGROUND OF THE INVENTION

The use of cellular phones in automobiles continues to increase and has created significant concern regarding the distraction that holding and talking into a cell phone causes to a driver. Several systems have been devised to support a cell phone. One is shown in U.S. Pat. No. 5,471,530. There the cell phone is supported on the door of the car at the bottom of the window. It would appear that such device would be inconvenient for entering or exiting the vehicle, as well as providing a potential hazard when the door is closed. U.S. Pat. No. 5,668,869 shows a cell phone holder which is supported on the shoulder portion of a seat belt. Because the shoulder strap is relatively loose, it would appear that such support would be insufficient for any practical use.

There is thus a need for an easily attached, and yet secure, cell phone support which is not affected by the closing of the car door or by the loosening of a seat belt shoulder strap.

### BRIEF SUMMARY OF THE INVENTION

It is an object of the present invention to provide a secure holder for a cellular phone for use in automobiles.

The present invention is for a cellular phone holder for supporting a cellular phone on the front seat of a motor vehicle to permit the driver to converse over the phone without taking his or her hands off the steering wheel. The cellular phone holder has a main base member with at least one front adjustable leg supported on the front of the main base member and at least one back adjustable leg also supported by the main base member. At least one front adjustable leg, and at least one back adjustable leg, are biased toward the center of the main base member so that they may be held over the top of the front seat of an automobile. A swivel base support member is supported on the main base member and holds a telescopic pivot arm. The telescopic pivot arm may telescope in and out as well as pivot up and down at a pivot point in the swivel base support member. A cell phone support pad is hingedly held at the outer end of the telescopic pivot arm and has a hook and eye, of the type sold under the trademark Velcro, attachment between the cell phone and the support pad. In use, the cell phone may be positioned so that the driver may both hear and talk over the cell phone without having to hold it. The device can, of course, be used with any size or shape of cell phone as long as it has an eye type of pad adhered to the back thereof.

### BRIEF DESCRIPTION OF THE DRAWINGS

FIG. 1 is a perspective view of the holder for supporting a cellular phone affixed to the front seat of an automobile and positioned so that the driver can talk and listen over the cell phone.

FIG. 2 is a side view of the holder of FIG. 1.

FIG. 3 is a top view thereof.

FIG. 4 is a side view, partly in cross-section thereof.

FIG. 5 is a top view of the distal end of the telescopic pivot arm showing the cell phone support pad.

FIG. 6 is a side view of the end of the telescopic pivot arm and the cell phone pad of the holder of FIG. 1.

FIG. 7 is a side view of an alternate embodiment of the adjustable leg of the holder of FIG. 1.

### DESCRIPTION OF THE PREFERRED EMBODIMENTS

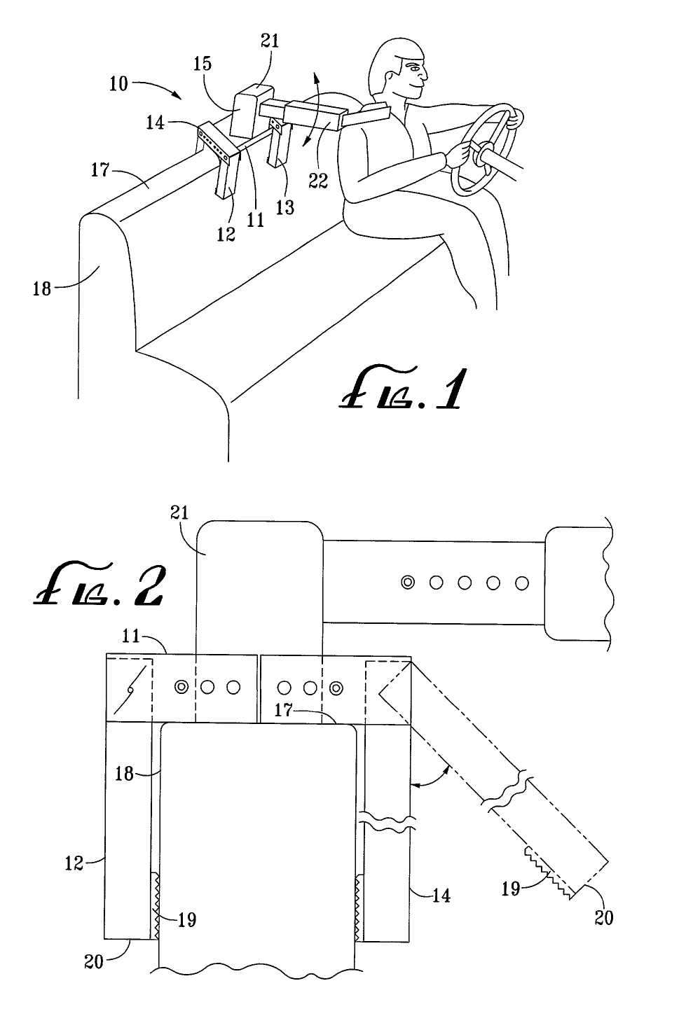

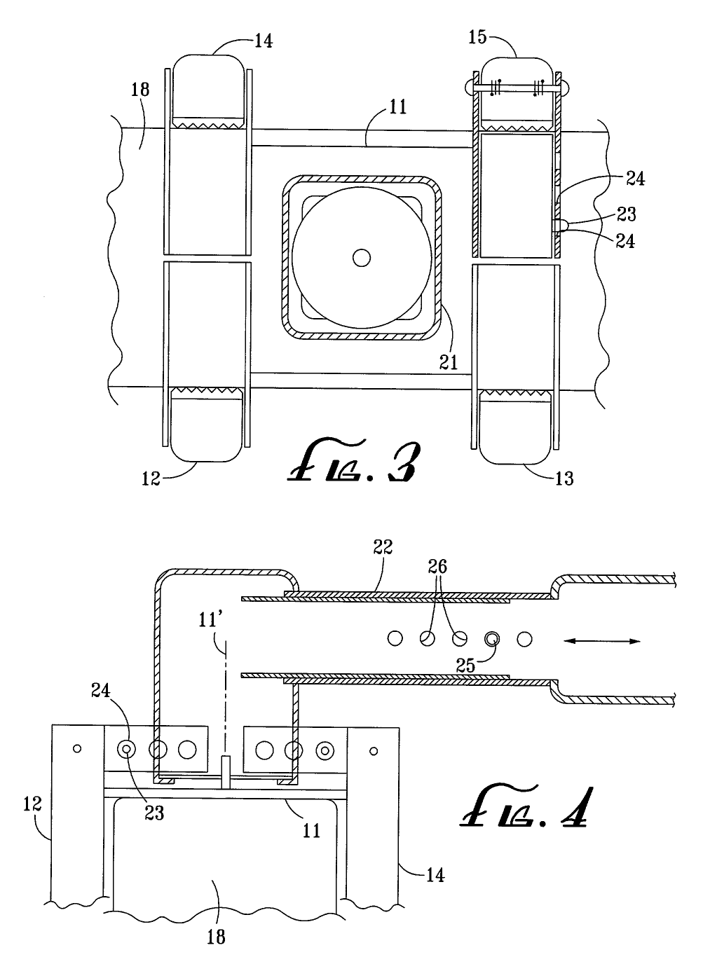

The holder for supporting a cellular phone on the front seat of an automobile is shown in perspective view in FIG. 1 and indicated generally by reference character 10. Holder 10 has a main base member 11 which hingedly supports two front adjustable legs 12 and 13. Main base member 11 also supports two adjustable rear legs 14 and 15 as shown in FIG. 3. These legs are also hingedly affixed, as shown best in FIG. 2 of the drawings. By having the legs hingedly and biasedly affixed to the base, they are able to clamp onto the top 17 of front seat 18. A pad 19 is preferably positioned at the bottom 20 of the adjustable legs as shown, for instance in FIG. 2.

Base 11 pivotally supports swivel base support member 21 about a vertical axis 11′. A telescopic pivot arm 22, as shown best in FIG. 4, is held by swivel base support member 21. The telescopic swivel arm supports a cellular phone as described below.

The adjustable legs are supported in a telescopic manner by main base member 11. One way of setting the distance is shown in FIG. 3 and accomplished by a spring loaded button 23 which may selectively extend out of one of the holes 24. In this way, the spacing between the front and rear legs may be adjusted depending on the thickness of the car seat. It is also contemplated that the legs may be spread further apart for support when spanning two bucket seats.

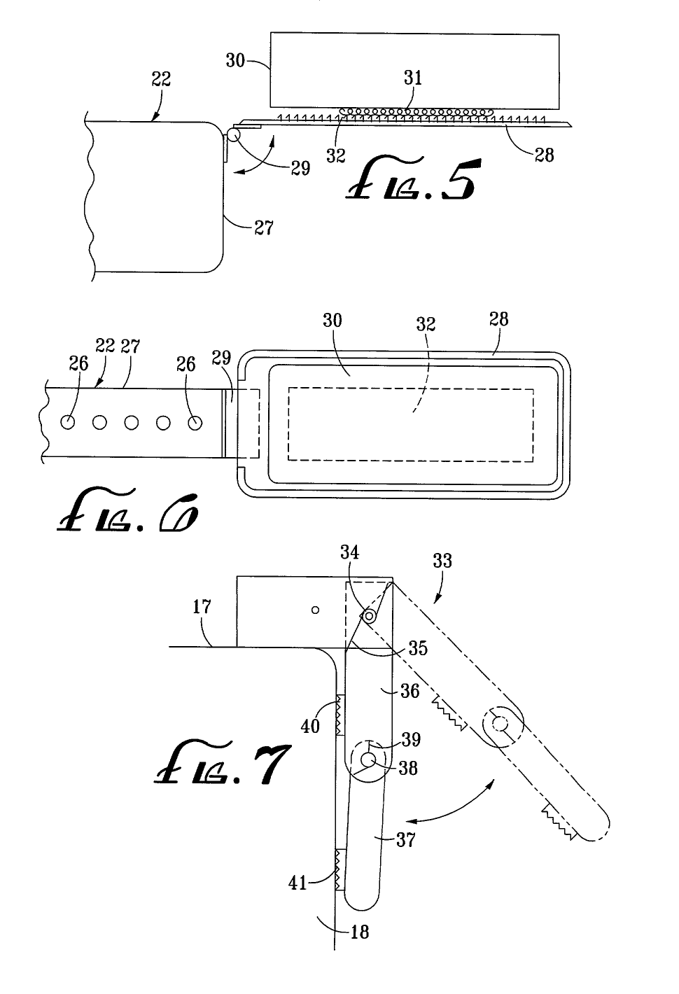

The telescopic pivot arm 22 is shown best in FIG. 4 of the drawings. Telescopic pivot arm 22 is also provided with a button 25 which may be selectively placed in any of holes 26 to telescopically adjust the length of telescopic pivot arm 22 as shown in FIG. 4. The distal end 27 of telescopic pivot arm 22 is shown in FIG. 5. A cell phone pad 28 is hingedly affixed to distal end 27 by friction hinge 29. This permits the angular adjustment of cell phone pad to a desired position to place cell phone 30 against the user's ear and to position the microphone near the user's mouth. A hook and eye combination holds cell phone 30 to cell phone pad 28. Preferably the eye portion 31 is affixed to the cell phone because of its softer nature and the hook portion 32 is secured to cell phone pad 28.

A front view of the distal end 27 of telescopic pivot arm 22 is shown in FIG. 6 where the preferred configuration of the cell phone pad can be seen.

Preferably, the adjustable legs are hinged at two places, as shown best in FIG. 7 of the drawings so that car seats which are undercut can still be gripped by the adjustable legs. Leg 33 has an upper portion 36 which is pivoted at pin 34 and urged inwardly by spring 35. Lower portion 37 of leg 33 is pivoted at pin 38 and urged inwardly by spring 39. A pair of pads 40 and 41 help secure leg 33 to car seat 18.

The pivoting of swivel base support member with respect to main base member 11 is adjustable by conventional friction means which may be secured by conventional tightening means. Similarly, the pivoting of the telescopic pivot arm 22 about a horizontal axis is also preferably controlled by an adjustable friction assembly of a conventional nature.

The result is a universal support apparatus for cellular phones which is easy to use and permits far less distraction to a driver while talking on a cellular phone. It may be fabricated from lightweight plastic, such as ABS and may be used on a wide variety of automobile or other motor vehicle seat constructions.

The present embodiments of this invention are thus to be considered in all respects as illustrative and not restrictive; the scope of the invention being indicated by the appended claims rather than by the foregoing description. All changes which come within the meaning and range of equivalency of the claims are intended to be embraced therein.

I claim:

1. A holder for supporting a cellular phone on the front seat of a motor vehicle to permit a driver of the motor vehicle to converse over the phone without taking his or her hand off the steering wheel of the motor vehicle, said holder comprising:
a main base member having a center, a front, and a back;
at least one front leg supported by said main base member at the front thereof, said at least one front leg being biased toward the center of the main base member;
at least one back leg supported by said main base member at the back thereof, said at least one back leg being biased toward the center of the main base member;
a swivel base support member pivotally supported about a vertical axis on said main base member above the center thereof;
a telescopic pivot arm held at a pivot end by said swivel base support member, said telescopic pivot arm being telescopically adjustable in length and said telescopic pivot arm having a phone end at a distal position thereof; and
a cell phone support pad hingedly held at the phone end of said telescopic pivot arm, said cell phone support pad including means for removably supporting a cell phone whereby a user may support a cell phone on said support pad and telescopically and pivotally position said telescopic pivot arm so that the cell phone is supported adjacent the user's ear and mouth and talk and listen on the cell phone without the necessity of releasing the steering wheel with either hand.

2. The holder for supporting a cellular phone of claim 1 wherein said holder has two front legs.

3. The holder for supporting a cellular phone of claim 1 wherein said holder has two back legs.

4. The holder for supporting a cellular phone of claim 1 wherein said at least one front leg has a biased upper portion held by said main base member and a biased lower portion held at a bottom end of said upper portion, both being biased toward said center.

5. The holder for supporting a cellular phone of claim 1 wherein said at least one back leg has a biased upper portion held by said main base member and a biased lower portion held at a bottom end of said upper portion of said at least one back leg, both being biased toward said center.

6. The holder for supporting a cellular phone of claim 1 wherein said cell phone support pad has a hook portion pad of a hook and eye fastener affixed thereto whereby a cell phone having an eye portion pad of a hook and eye fastener may be releasably held to said cell phone support pad.

7. A holder for supporting a cellular phone on the front seat of a motor vehicle to permit a driver of the motor vehicle to converse over the phone without taking his or her hand off the steering wheel of the motor vehicle, said holder comprising:
a main base member having a center, a front, and a back;
a pair of front legs supported by said main base member at the front thereof, said pair of front legs being biased toward the center of the main base member;
a pair of back legs supported by said main base member at the back thereof, said pair of back legs being biased toward the center of the main base member;
a swivel base support member pivotally supported about a vertical axis on said main base member above the center thereof and being pivotally supported about a horizontal axis on said main base member;
a telescopic pivot arm held at a pivot end by said swivel base support member, said telescopic pivot arm being telescopically adjustable in length and said telescopic pivot arm having a cellular phone supporting end at a distal position thereof; and
a cell phone support pad hingedly held at the cellular phone supporting end of said telescopic pivot arm, said cell phone support pad including means for removably supporting a cell phone whereby a user may support a cell phone on said support pad and telescopically and pivotally position said telescopic pivot arm so that the cell phone is supported adjacent the user's ear and mouth and talk and listen on the cell phone without the necessity of releasing the steering wheel with either hand.

8. The holder for supporting a cellular phone of claim 7 wherein the pair of front legs and the pair of back legs may be adjustably moved closer or further apart at a point of attachment to said main base member to compensate for seats of a different thickness.

9. The holder for supporting a cellular phone of claim 7 wherein said pair of front legs and said pair of back legs each have a biased upper portion held by said main base member and a biased lower portion held at a bottom end of said upper portion, both being biased toward said center.
